(19) United States
(12) Patent Application Publication
(10) Pub. No.: US 2014/0259043 A1
(43) Pub. Date: Sep. 11, 2014

(54) GATHERING AND USING INFORMATION REGARDING VIEWERS' FAMILIARITY WITH MEDIA-CONTENT ITEMS

(71) Applicant: GENERAL INSTRUMENT CORPORATION, Horsham, PA (US)

(72) Inventor: James M. Hunter, San Jose, CA (US)

(73) Assignee: GENERAL INSTRUMENT CORPORATION, Horsham, PA (US)

(21) Appl. No.: 13/793,328

(22) Filed: Mar. 11, 2013

(51) Int. Cl. H04N 21/4784

(52) U.S. Cl. CPC H04N 21/4784
USPC 725/23

(57) ABSTRACT

When an advertisement is presented to a viewer, that viewer is also presented with a question related to the contents of the advertisement. The viewer is rewarded if he correctly answers the question. In some embodiments, the reward is the cancellation of the unviewed portion of the advertisement. The viewer's response is directly related to this viewer's familiarity with and reaction to the advertising campaign. Information about that response is gathered and analyzed. If it is determined that the viewer is sufficiently aware of this advertisement, then a different advertisement could be sent in the future to avoid boring the viewer. Responses from several viewers could be used to determine when a particular phase of an advertising campaign has reached an optimum “saturation” level among the viewers. The campaign can then move on to the next phase.

### CROSS-REFERENCE TO RELATED APPLICATIONS

The present application is related to U.S. patent application (Motorola Docket Number CS41319), filed on an even date herewith.

### TECHNICAL FIELD

The present disclosure is related generally to media-content delivery and, more particularly, to gathering viewer-response information.

### BACKGROUND

Personalized advertising is becoming much more common. Here, an advertiser wishes to present advertising that is specially relevant to each particular viewer. This particularization makes advertising campaigns much more efficient and, when carefully crafted, tends to be less annoying to viewers than traditional “blanket” campaigns where the same message is sent to all of the viewers.

To effectively personalize an advertising campaign requires, of course, that the advertiser knows something in particular about each individual viewer. Also, the personalization can effectively develop over time if the advertiser can determine how each viewer responds to the ongoing campaign.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is an overview of a representative environment in which the present techniques may be practiced;

FIG. 2 is a generalized schematic of some of the devices of FIG. 1;

FIGS. 3 and 4 are flowcharts of representative methods for gathering information regarding a viewer's familiarity with a media-content item; and

FIGS. 5a through 5c are flowcharts of representative methods for using information regarding a viewer's familiarity with a media-content item.

### DETAILED DESCRIPTION

Turning to the drawings, wherein like reference numerals refer to like elements, techniques of the present disclosure are illustrated as being implemented in a suitable environment. The following description is based on embodiments of the claims and should not be taken as limiting the claims with regard to alternative embodiments that are not explicitly described herein.

Today's directed advertising campaigns, where viewer information is used to direct specific ads to specific viewers, do not include mechanisms for directly measuring the effectiveness of the personalization of the campaign. Thus, it is generally not known how useful this personalization is. Also, there is little information on which to base a change in the campaign, other than the continued gathering of viewer-profile and viewer-behavior information on which the personalization was originally based.

According to aspects of the present disclosure, when an advertisement (or other secondary content item) is presented to a viewer, that viewer is also presented with a question related to the contents of the advertisement. The viewer is rewarded if he correctly answers the question. In some embodiments, the reward is the cancellation of the unviewed portion of the advertisement. Thus, if it is determined that this viewer is familiar enough with this particular advertisement to answer the question quickly, then he is rewarded by not having to sit through the entire ad. Other incentives are contemplated.

Thus, the viewer's response is directly related to this viewer's familiarity with and reaction to the advertising campaign. Information about that response is gathered and analyzed. If it is determined that the viewer is sufficiently aware of this advertisement, then, in some situations, a different advertisement could be sent in the future to avoid boring the viewer. Responses from several viewers could be used to determine when a particular phase of an advertising campaign has reached an optimum “saturation” level among the viewers. The campaign can then move on to the next phase, at least among those viewers who answered the questions most readily. In some embodiments, the response times of different viewers using different types of devices could be analyzed to determine that, for example, a user interface of one type of device is sub-optimal, leading to increased response time and possibly to viewer frustration. An updated user interface could then be developed and deployed for that device type.

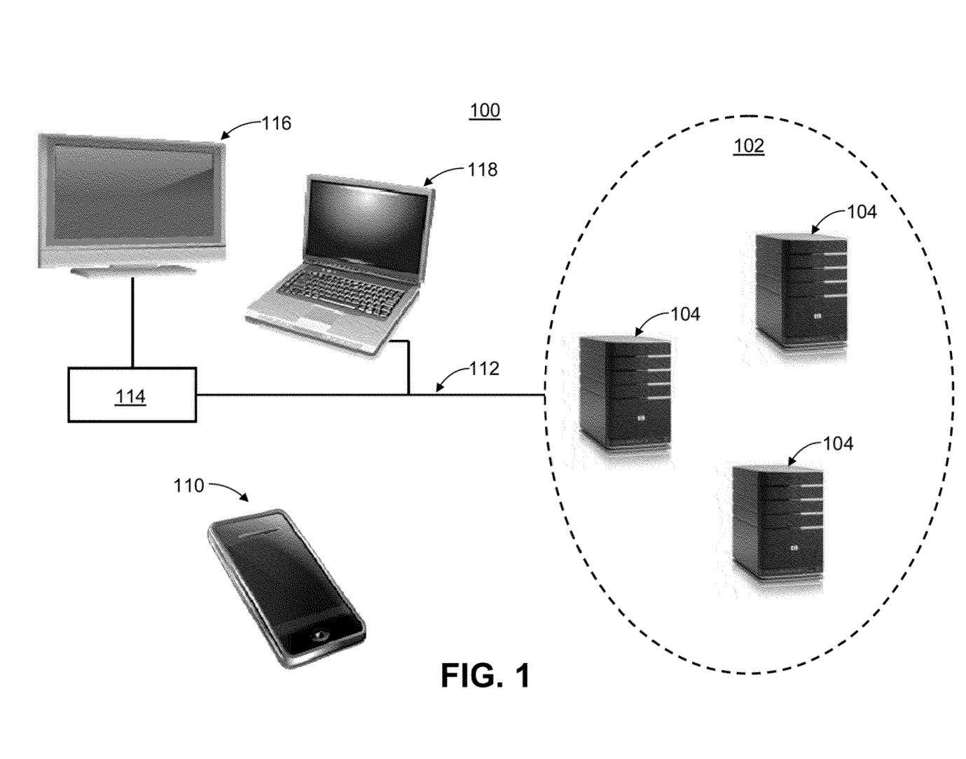

To understand these concepts more fully, first consider the representative communications environment 100 of FIG. 1. Connected together via any or all of various known networking technologies 102 are various media-content servers 104 (e.g., television-programming servers, web servers, and the like). (The functions of these servers 104 are discussed below.) Some of the media-content servers 104 may head-end a cable-television delivery system 112. For ease of illustration, only three servers 104 are shown, but numerous servers 104 can exist and can work together, as discussed below.

In an actual implementation of the communications environment 100, the functions of the servers 104 may all reside on one computing platform, may be hosted separately on separate servers (as depicted in FIG. 1), or may each be spread out among several computing platforms. Indeed, at least some aspects of these functions may be embodied on any number of computing devices including a set-top box 114, a personal communications device, a television 116, a mobile telephone 110, a personal digital assistant, a personal computer 118, a tablet computer, a gaming console, a media-restreaming device, and a plurality of servers. Rather than mentioning these implementation possibilities again, the present discussion refers to these functions as if they were all hosted on the servers 104 as shown in FIG. 1.

Head-end servers 104 provide, via the networking technologies 102, media-download and television services to end-user devices. Non-wireless end-user devices are supported by “wireline” network technologies (e.g., fiber, wire, and cable) 112. For example, a set-top box 114 generally receives television programming from a head-end server 104 and provides a user interface (e.g., an interactive program guide) for selecting and viewing content from the head-end server 104. A digital video recorder (not shown) can store programming for later viewing. The video content may be viewed on a television monitor 116. In some situations, a laptop computer 118 accesses web-based services either wirelessly or via the wireline network 112. A gaming console, home gateway, kiosk, digital sign, or media-restreaming device (not shown) are other possible end-user devices. Options for connecting these devices and services are well known in the art and need not be further discussed.

(A media-restreaming device transfers content between disparate types of networks. For example, it receives content from the cable system 112 and then transmits that content over a local radio link such as WiFi to a smartphone 110. The media-restreaming device usually operates in both directions to carry messages between the networks. In some embodiments, aspects of the present invention are practiced by a media-restreaming device.)

Television programming (and other media content) can also be delivered to non-traditional subscriber devices such as the smartphone 110. This smartphone 110 communicates wirelessly to a wireless base station (not shown but known in the art) to access the public switched telephone network, the Internet, or other networks to access web-based services as well as the television-delivery services provided by the media-content providers 104.

Wireless and wireline network technologies generally support two-way traffic: Media content and related information are delivered to the end-user devices 110, 114, 116, 118, and requests and other information go “up” to the servers 104.

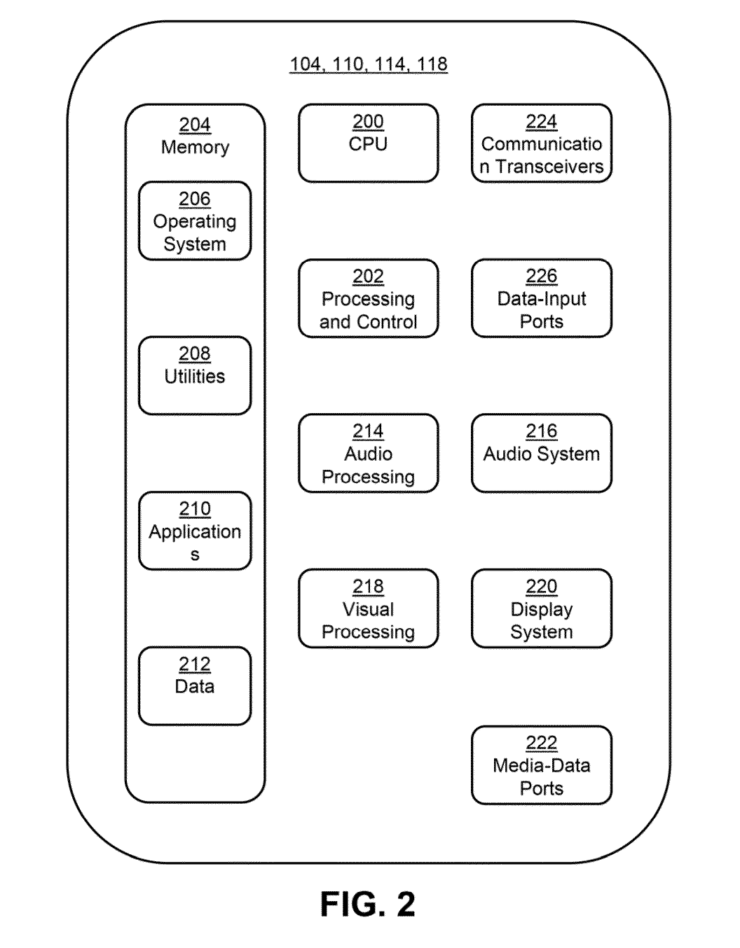

FIG. 2 shows the major components of a representative electronics device 104, 110, 114, 118. The device 110, 114, 118 could be a personal electronics device (such as a smart phone, tablet, personal computer, electronic book, or gaming console) or a set-top box. The media-content server 104 could be any of these and could also be a compute server or a plurality of servers working together in a coordinated fashion.

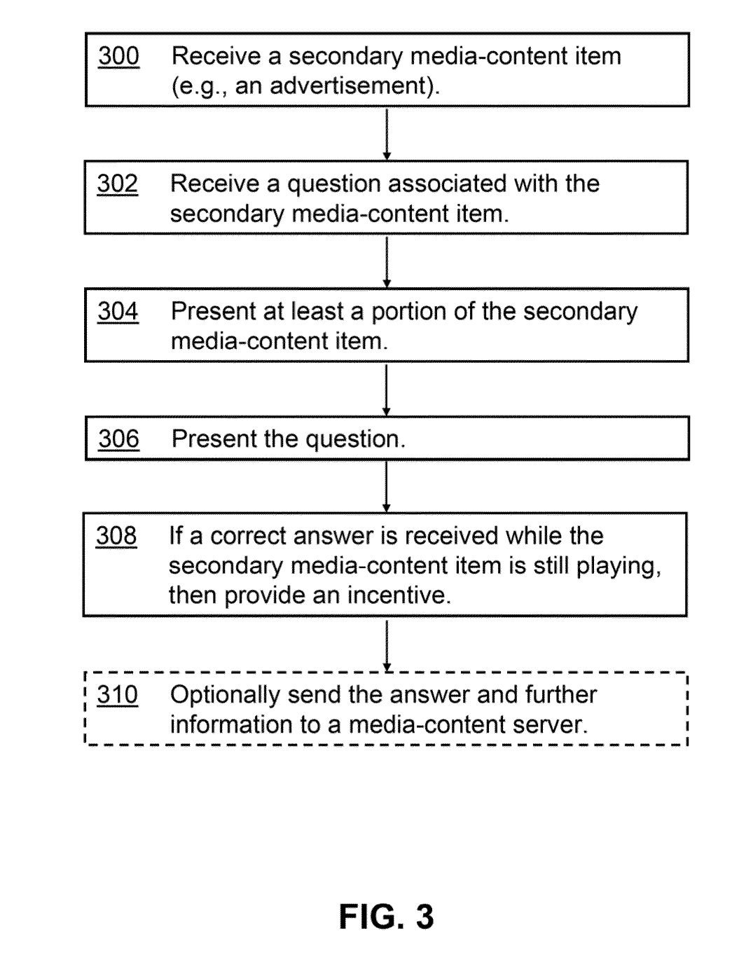

The CPU 200 of the electronics device 104, 110, 114, 118 includes one or more processors (i.e., any of microprocessors, controllers, and the like) or a processor and memory system which processes computer-executable instructions to control the operation of the device 104, 110, 114, 118. In particular, the CPU 200 supports aspects of the present disclosure as illustrated in FIGS. 3 through 5, discussed below. The device 104, 110, 114, 118 can be implemented with a combination of software, hardware, firmware, and fixed-logic circuitry implemented in connection with processing and control circuits, generally identified at 202. Although not shown, the device 104, 110, 114, 118 can include a system bus or data-transfer system that couples the various components within the device 104, 110, 114, 118. A system bus can include any combination of different bus structures, such as a memory bus or memory controller, a peripheral bus, a universal serial bus, and a processor or local bus that utilizes any of a variety of bus architectures.

The electronics device 104, 110, 114, 118 also includes one or more memory devices 204 that enable data storage, examples of which include random-access memory, non-volatile memory (e.g., read-only memory, flash memory, EPROM, and EEPROM), and a disk storage device. A disk storage device may be implemented as any type of magnetic or optical storage device, such as a hard disk drive, a recordable or rewriteable disc, any type of a digital versatile disc, and the like. The device 104, 110, 114, 118 may also include a mass-storage media device.

The memory system 204 provides data-storage mechanisms to store device data 212, other types of information and data, and various device applications 210. An operating system 206 can be maintained as software instructions within the memory 204 and executed by the CPU 200. The device applications 210 may also include a device manager, such as any form of a control application or software application. The utilities 208 may include a signal-processing and control module, code that is native to a particular component of the electronics device 104, 110, 114, 118, a hardware-abstraction layer for a particular component, and so on.

The electronics device 104, 110, 114, 118 can also include an audio-processing system 214 that processes audio data and controls an audio system 216 (which may include, for example, speakers). A visual-processing system 218 processes graphics commands and visual data and controls a display system 220 that can include, for example, a display screen. The audio system 216 and the display system 220 may include any devices that process, display, or otherwise render audio, video, display, or image data. Display data and audio signals can be communicated to an audio component or to a display component via a radio-frequency link, S-video link, High-Definition Multimedia Interface, composite-video link, component-video link, Digital Video Interface, analog audio connection, or other similar communication link, represented by the media-data ports 222. In some implementations, the audio system 216 and the display system 220 are components external to the device 104, 110, 114, 118. Alternatively (e.g., in a cellular telephone), these systems 216, 220 are integrated components of the device 104, 110, 114, 118.

The electronics device 104, 110, 114, 118 can include a communications interface which includes communication transceivers 224 that enable wired or wireless communication. Example transceivers 224 include Wireless Personal Area Network radios compliant with various IEEE 802.15 standards, Wireless Local Area Network radios compliant with any of the various IEEE 802.11 standards, Wireless Wide Area Network cellular radios compliant with 3GPP standards, Wireless Metropolitan Area Network radios compliant with various IEEE 802.16 standards, and wired Local Area Network Ethernet transceivers.

The electronics device 104, 110, 114, 118 may also include one or more data-input ports 226 via which any type of data, media content, or inputs can be received, such as user-selectable inputs (e.g., from a keyboard, from a touch-sensitive input screen, or from another user-input device), messages, music, television content, recorded video content, and any other type of audio, video, or image data received from any content or data source. The data-input ports 226 may include USB ports, coaxial-cable ports, and other serial or parallel connectors (including internal connectors) for flash memory, storage disks, and the like. These data-input ports 226 may be used to couple the device 104, 110, 114, 118 to components, peripherals, or accessories such as microphones and cameras.

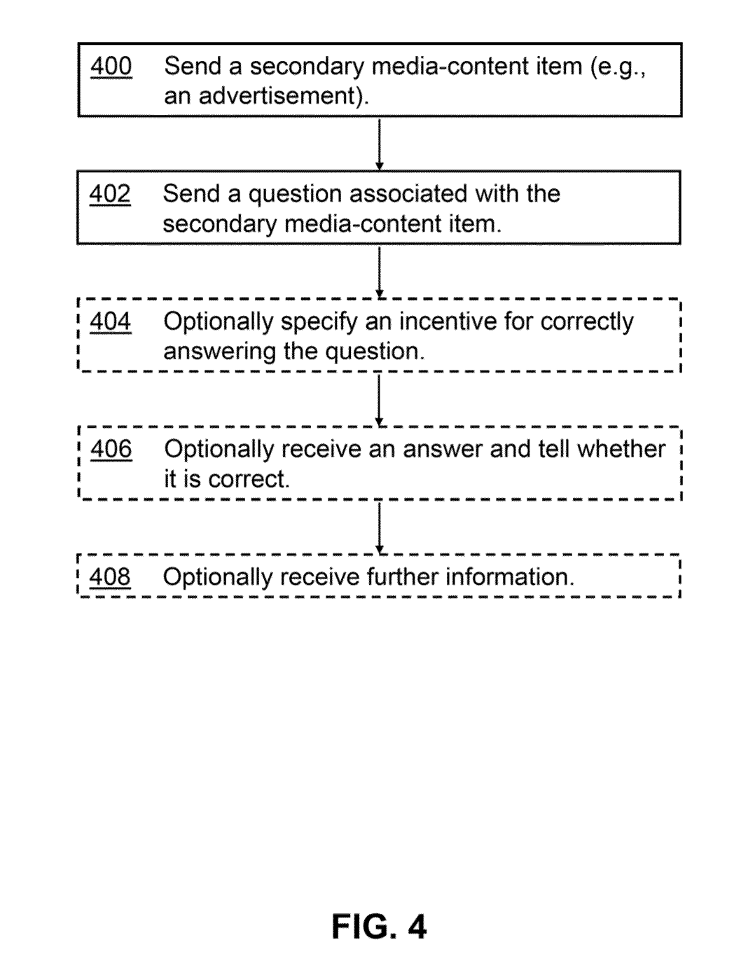

FIGS. 3 and 4 together present a method for measuring a viewer's familiarity with a “secondary media-content item” (e.g., an advertisement, a public-service announcement, a reminder, or a service alert). FIG. 3 presents aspects of the method as they directly affect the viewer, while FIG. 4 presents aspects performed by one or more media-content servers 104.

To understand the methods of FIGS. 3 and 4, consider a viewer watching a movie (a “primary media-content item”) on the television monitor 116. In step 400 of FIG. 4, a media-content server 104 sends him the secondary media-content item. In some embodiments, the server 104 that sends the secondary media-content item is the same as the cable head-end server 104 that is sending the primary media-content item. In other embodiments, these functions are provided by different servers 104.

In step 300 of FIG. 3, the secondary media-content item (or at least a part of it) is received, possibly at the viewer's set-top box 114. If the viewer were watching the primary media-content item on his smartphone 110 instead of on the television monitor 116, then, because there is no set-top box 114 driving the smartphone 110, the secondary media-content item would be sent directly to the smartphone 110. (Note that the secondary media-content item is not yet presented to the view in this step 302.)

Similarly, a question associated with the secondary media-content item is sent in step 402 of FIG. 4 and received in step 302 of FIG. 3. The media-content server 104 sending the question in step 402 need not be the same as the server 104 that sent the secondary media-content item in step 400.

Optionally, the media-content server 104 specifies in step 404 an incentive to be provided to the viewer if he correctly answers the question in a specified amount of time. This step, though important, is considered to be optional because, in some embodiments, the incentive is always the same and thus need not be explicitly stated.

The steps discussed above can all be considered as set-up for what happens next. In step 304 of FIG. 3, the secondary media-content item begins to be displayed to the viewer. In a traditional one-screen situation, the primary media-content item is paused while the secondary media-content item is playing. Alternatively, the secondary media-content item is displayed on the screen of a “companion device” 110 while the primary media-content item continues to play on the television monitor 116.

In any case, while the secondary media-content item is still playing, the question is presented to the viewer in step 306. The question could be of any format, such as video, audio-only, or text. The content of the question is related to the content of the secondary media-content item, and it is meant to allow the viewer to show that he is familiar with this particular secondary media-content item. An example question could be: “What type of animal shows up at the end of this advertisement?”

The viewer is given the opportunity to try to answer the question. Different modalities may be supported so that, for example, the viewer could type in an answer, speak an answer, or select an answer from a multiple-choice display. The viewer's answer, if any, is checked for correctness in step 308. In some embodiments, the media-content server 104 sends down the correct answer along with the question in step 402 of FIG. 4, so that the answer checking can be performed locally, e.g., on the viewer's set-top box 114. In other embodiments, the viewer's answer is reported to the server 104. In this case, the server 104 checks the answer in step 406 of FIG. 4 and tells the viewer's device whether the answer is correct or not.

If the viewer correctly answers the question in a specified amount of time (usually while the secondary media-content item is still playing), then he receives the incentive. In some cases, the incentive is that the secondary media-content item stops playing immediately, and the viewer is returned to the primary media-content item. The thinking is that there is no need for this viewer to sit through this secondary media-content item again if he already knows its contents.

Other incentives are also possible such as a discount or coupon for a product or service advertised by the secondary media-content item. If the viewer is a gamer, then he may be given access to special game functionality or game information. Sometimes, social-presence information or membership in a group could be provided. The incentive could even be the provision of a puzzle to play or the removal of some disincentive.

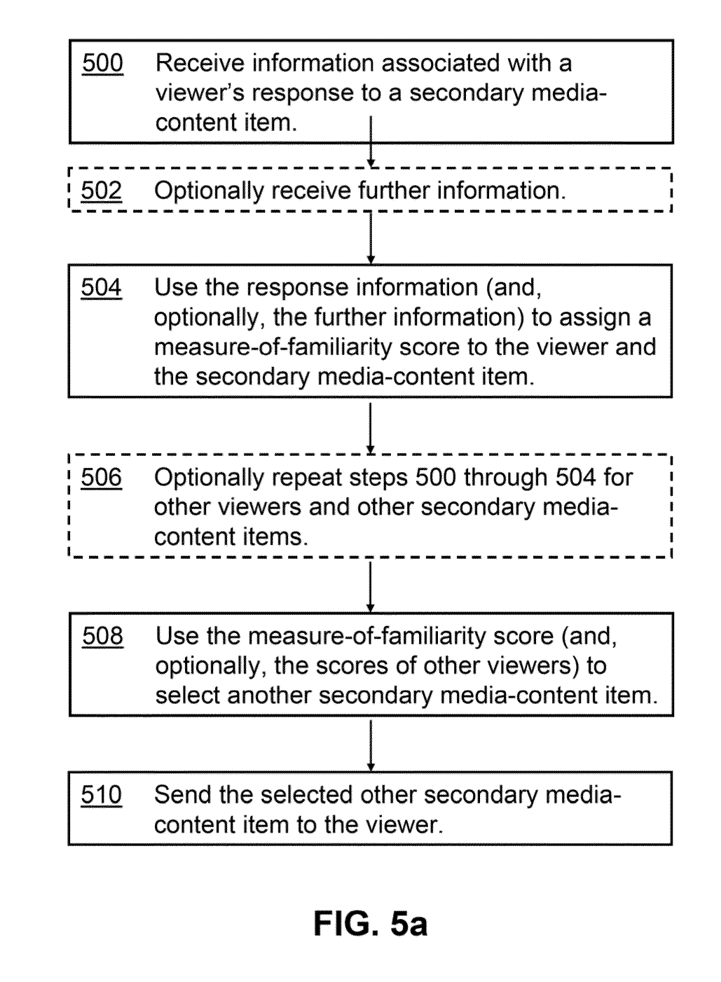

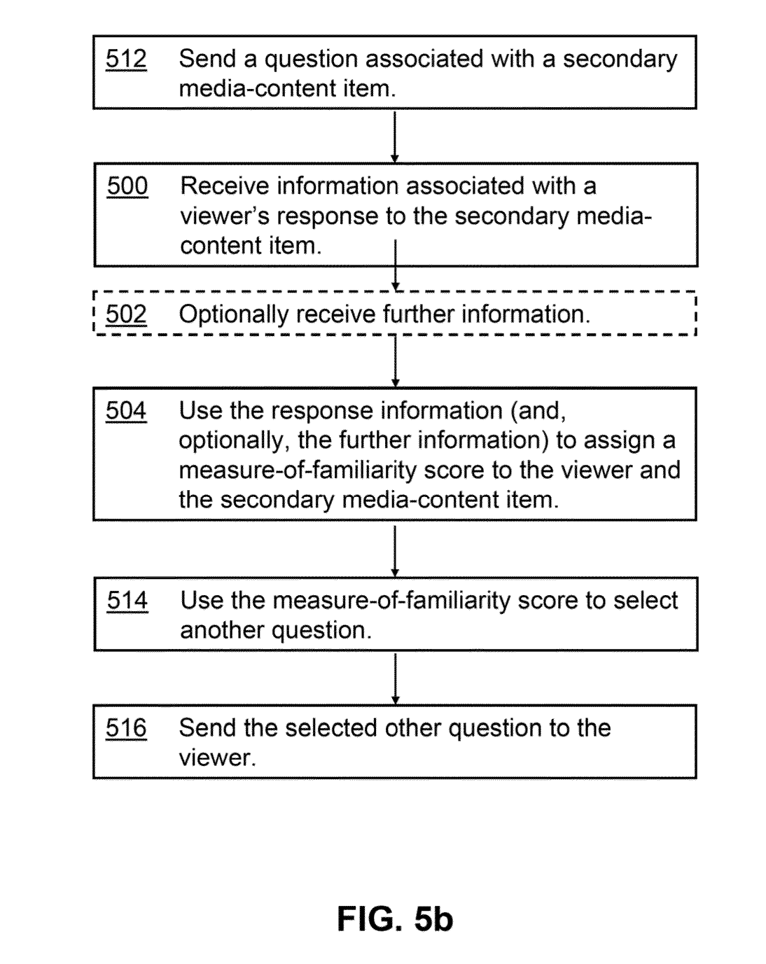

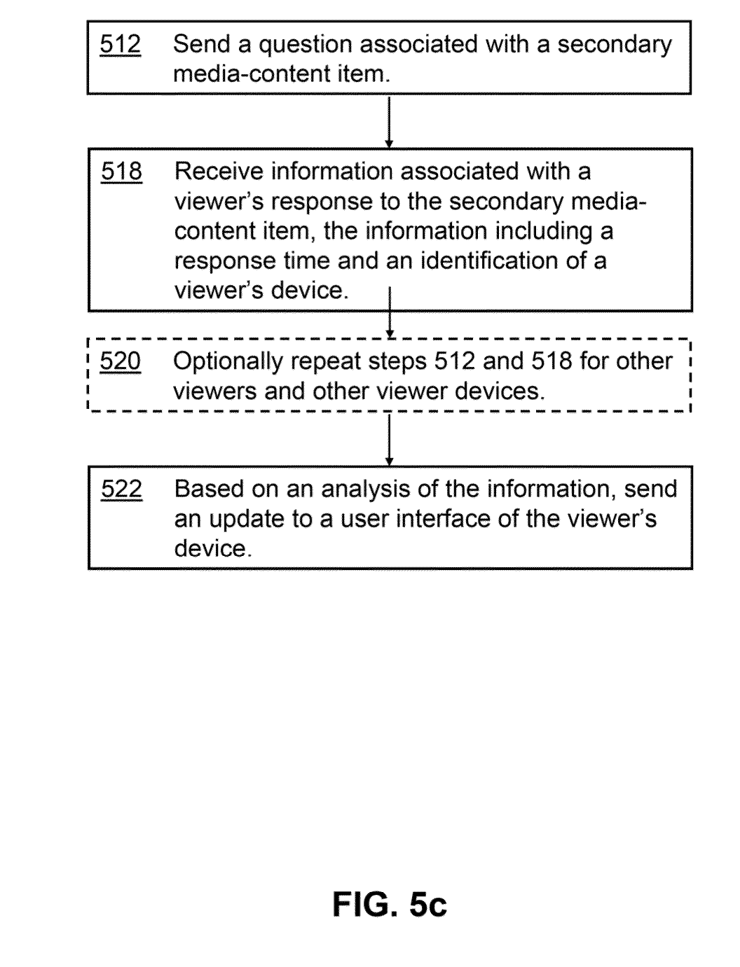

In optional step 310, information about the viewer and about his response are sent to the media-content server 104. In addition to the viewer's answer (whether correct or not), this information could include the viewer's response time, the type of device he answered from, profile and demographic information about the viewer, and social-presence information (i.e., who else is watching with the viewer). This information is received by the server 104 in step 408 of FIG. 4. Possible uses of this information are discussed below in reference to FIGS. 5a through 5c.

Although not shown, the methods of FIGS. 3 and 4 can optionally continue. If, for example, the viewer fails to provide the correct answer while the secondary media-content item is still playing, that may be taken as an indication that this viewer has not yet sufficiently absorbed the message of the secondary media-content item. In response, the secondary media-content item may be again scheduled for this viewer at a later time, with the same or with a different question to see if the message is sinking in.

As mentioned above, FIGS. 5a through 5c present a few possibilities for using the valuable information gathered by the methods of FIGS. 3 and 4. In step 500 and in the optional step 502 of FIG. 5a, a media-content server 104 receives information about a viewer's response to a question. Such information could include his answer and his response time, that is, how long it took him to provide his answer. As mentioned above in reference to step 408 of FIG. 4, the further information could also include profile, demographic, and social-presence information.

Based on the received information, a measure-of-familiarity score is assigned in step 504. This score captures how familiar this particular viewer is with this particular secondary media-content item. Clearly, a correct answer leads to a high familiarity score. A low response time, when coupled with the correct answer, could increase the score.

Step 506, though technically optional, is expected to be performed in most embodiments. In this step 506, information is gathered from other viewers of this and of other secondary media-content items. Measure-of-familiarity scores are assigned.

The measure-of-familiarity score of this viewer (and potentially that of other viewers) is used in step 508 to select another secondary media-content item. This can be done when the viewer, or the population of viewers, is deemed to be sufficiently familiar with the message of the original secondary media-content item. In the case of a phased advertising campaign, this could mean that the current stage has done its work, and it is time to begin the next phase (at least for those viewers who responded correctly). Alternatively, universally low measure-of-familiarity scores might indicate that the message of the original secondary content item is simply not getting through. An update or replacement may be needed to get the campaign back on track.

In any case, the newly selected secondary media-content item is sent out in step 510. In some embodiments, of course, it can be sent using the methods of FIGS. 3 and 4 to begin the cycle anew.

FIG. 5b presents another use of the information provided by the methods of FIGS. 3 and 4. It begins with step 512 where (as in step 402 of FIG. 4) a first question is sent out to a viewer, the question associated with a secondary media-content item also sent to the viewer.

The method of FIG. 5b proceeds, in steps 500 through 504, to gather viewer-response information and to assign a measure-of-familiarity score just as discussed in reference to FIG. 5a.

Then in step 514, the measure-of-familiarity score is used in selecting a second question, this second question also associated with the same secondary media-content item. The second question is sent out in step 516. Though not shown, step 516 implies that a method like that of FIG. 3 could be used to present the second question to a viewer and to gather response information.

There may be several reasons for changing to the second question. A very low measure-of-familiarity score (especially when matched by similar low scores among the population) may indicate that the first question is simply confusing and is thus not a good measure of the viewer's familiarity with the secondary media-content item. Alternatively, if a viewer has a high score, then he may be answering so quickly that he ignores the secondary media-content item entirely. It could be a good idea to refocus his attention by changing to a different question.

FIG. 5c presents yet another more way to use the viewer-response information. In step 512, a question is sent out, as in the methods of FIGS. 3 and 4. Viewer-response information is gathered as before, in step 518. However, this time the information includes the viewer's response time and an identification of the device he used when responding. Optional step 520 gathers this same sort of viewer-response information from other viewers potentially using other types of devices.

The gathered information is analyzed in step 522. If, for example, the information indicates that viewers using one particular type of device take longer to respond to a given question, then it could be that the user interface presented by that device for answering questions is clumsy to use. Other inferences may also be drawn. Developers could use this information to modify, maybe streamline, the troublesome user interface and send out an updated version.

FIGS. 5a through 5c present three possible uses of the viewer-response information gathered by the methods of FIGS. 3 and 4, but other uses are possible and contemplated.

In view of the many possible embodiments to which the principles of the present discussion may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A method for presenting a question associated with a secondary media-content item, the method comprising:
receiving, by a media-presentation device, at least a portion of the secondary media-content item;
receiving, by the media-presentation device, the question associated with the secondary media-content item;
presenting, by the media-presentation device, at least a portion of the secondary media-content item;
presenting, by the media-presentation device, the question; and
if a correct answer to the question is received before the secondary media-content item has been completely presented, then:
providing an incentive.

2. The method of claim 1 wherein the secondary media-content item is selected from the group consisting of: an advertisement, a public-service announcement, a reminder, and a service alert.

3. The method of claim 1 wherein a format of the question is selected from the group consisting of: text, audio-only, video-only, and a combination of audio and video.

4. The method of claim 1 wherein the incentive includes an element selected from the group consisting of: a discount, a coupon, a cash equivalent, a service improvement, access to functionality, a game clue, a puzzle, a customized service, social-presence information, membership in a group, shopping information, and removal of a disincentive.

5. The method of claim 1 wherein providing an incentive comprises stopping the presenting of the secondary media-content item.

6. The method of claim 5 where stopping the presentation comprises presenting at least a portion of a primary media-content item.

7. The method of claim 6 wherein the primary and secondary media-content items are presented on distinct devices.

8. The method of claim 1 further comprising:
sending, by the media-presentation device to a media-content server, a received answer.

9. The method of claim 8 further comprising:
receiving, by the media-presentation device from the media-content server, an indication that the received answer is correct.

10. The method of claim 8 further comprising:
sending, by the media-presentation device to the media-content server, further information selected from the group consisting of: viewer-profile information, viewer-demographics information, social-presence information, time to respond to the question, and an indication of a type of device used.

11. The method of claim 1 further comprising:
if no correct answer to the question is received before the secondary media-content item has been completely presented, then:
receiving, by the media-presentation device, a second question associated with the secondary media-content item;
presenting, by the media-presentation device, at least a portion of the secondary media-content item;
presenting, by the media-presentation device, the second question; and
if a correct answer to the second question is received before the secondary media-content item has been completely presented, then:
providing an incentive.

12. The method of claim 11 wherein the question and the second question are the same.

13. A media-presentation device configured for presenting a question associated with a secondary media-content item, the media-presentation device comprising:
a communications interface configured for receiving at least a portion of the secondary media-content item and for receiving the question associated with the secondary media-content item; and
a processor operatively connected to the communications interface and configured for:
presenting at least a portion of the secondary media-content item;
presenting the question; and
if a correct answer to the question is received before the secondary media-content item has been completely presented, then:
providing an incentive.

14. The media-presentation device of claim 13 wherein the media-presentation device is selected from the group consisting of: a personal electronics device, a mobile telephone, a personal digital assistant, a computer, a tablet computer, a set-top box, a gaming console, a compute server, and a coordinated group of compute servers.

15. A method for sending a question associated with a secondary media-content item, the method comprising:
sending, by a media-content server to a media-presentation device, at least a portion of the secondary media-content item; and
sending, by the media-content server to the media-presentation device, the question associated with the secondary media-content item.

16. The method of claim 15 wherein the secondary media-content item is selected from the group consisting of: an advertisement, a public-service announcement, a reminder, and a service alert.

17. The method of claim 15 wherein a format of the question is selected from the group consisting of: text, audio-only, video-only, and a combination of audio and video.

18. The method of claim 15 further comprising:
specifying an incentive associated with answering the question correctly, wherein the incentive includes an element selected from the group consisting of: stopping the presenting of the secondary media-content item, a discount, a coupon, a cash equivalent, a service improvement, access to functionality, a game clue, a puzzle, a customized service, social-presence information, membership in a group, shopping information, and removal of a disincentive.

19. The method of claim 15 further comprising:
receiving, by the media-content server from the media-presentation device, an answer.

20. The method of claim 19 further comprising:
sending, by the media-content server to the media-presentation device, an indication that the answer is correct.

21. The method of claim 19 further comprising:
receiving, by the media-content server from the media-presentation device, further information selected from the group consisting of: viewer-profile information, viewer-demographics information, social-presence information, time to respond to the question, and an indication of a type of device used.

22. A media-content server configured for sending a question associated with a secondary media-content item, the media-content server comprising:
a communications interface configured for sending, to a media-presentation device, at least a portion of the secondary media-content item and for sending, to the media-presentation device, the question associated with the secondary media-content item; and
a processor operatively connected to the communications interface.

23. The media-content server of claim 22 wherein the media-content server is selected from the group consisting of: a personal electronics device, a mobile telephone, a personal digital assistant, a computer, a tablet computer, a set-top box, a gaming console, a compute server, and a coordinated group of compute servers.
